(19) United States
(12) Patent Application Publication
(10) Pub. No.: US 2008/0190368 A1
(43) Pub. Date: Aug. 14, 2008

(54) Arrangement For Supplying A Liquid Medium To A Teat Of An Animal

(75) Inventor: Lars Wase, Danderyd (SE)

Correspondence Address: HOVEY WILLIAMS LLP, 10801 Mastin Blvd., Suite 1000, Overland Park, KS, 66210, US

(73) Assignee: DeLaval Holding AB, Tumba (SE)

(21) Appl. No.: 11/911,484

(22) PCT Filed: Apr. 10, 2006
(86) PCT No.: PCT/SE06/00422

§ 371 Date: Oct. 12, 2007

(30) Foreign Application Priority Data
Apr. 14, 2005 (SE) 0500843-8

(51) Int. Cl. A01J 7/04

(52) U.S. Cl. 119/14.18

(57) ABSTRACT

The invention relates to an arrangement for supplying a liquid to a teat-cleaning cup. The arrangement includes a cup-shaped body (1), a liquid medium source (3), at least one liquid medium passage (5, 5′) having an extension from the first medium source (3) to at least one opening to the cup-shaped body (1), and at least one feeding member. The feeding member includes a piston element (9, 9a-c, 9a′-c′) having a first surface (, which constitutes a wall surface of a first chamber (5b, 5b′) of the passage (5, 5′) and a motion source arranged to provide a motion of the piston element (9, 9a-c, 9a′-c′) in a first feeding direction in the first chamber (5b, 5b′), such that the liquid medium is fed to the cup-shaped body (1).

### BACKGROUND OF THE INVENTION AND PRIOR ART

The present invention relates to an arrangement for supplying a liquid medium to a teat of an animal, wherein the arrangement comprises a cup-shaped body, which is arranged to receive the teat of the animal, a liquid medium source, which contains the liquid medium to be supplied to the animal, at least one liquid medium passage having an extension from the first medium source to at least one opening to the cup-shaped body and a feeding member arranged to feed a desired quantity of the liquid medium through the passage to the cup-shaped body.

WO 01/17337 shows an example of a teat-cleaning cup according to the above. Teat-cleaning cups are usually used for cleaning the respective teats of an animal before a milking member is attached to the animal. In this case, a desired quantity of a cleaning liquid is supplied to a conduit connected to the teat-cleaning cup by means of a first valve connected to a cleaning liquid source. Thereafter, a compressed air source is connected to the conduit by means of a second valve. Thereby, the compressed air in the conduit feeds the supplied cleaning liquid in a direction towards the teat-cleaning cup.

The compressed air is here in direct contact with the cleaning liquid in the conduit. However, such a feeding of the cleaning liquid requires a relatively high consumption of compressed air.

### SUMMARY OF THE INVENTION

The object of the present invention is to achieve a feeding of a liquid medium to a teat of an animal in a simple and effective manner with relatively low energy consumption.

This object is obtained according to the invention by the feature that said feeding member comprises a piston element having a first surface, which constitutes a wall surface of a first chamber of the passage, and means arranged to provide a motion of the piston element in a first feeding direction in the first chamber such that the liquid medium is fed to the cup-shaped body. Usually, the liquid medium passage between the first chamber and the opening to the cup-shaped body is relatively narrow. Furthermore, the liquid medium passage comprises a plurality of portions in which a flowing liquid obtains relatively large losses of pressure. Consequently, if the liquid medium has to be supplied to the cup-shaped body with a desired pressure, the feeding member has to be able to supply a relatively large pressure to the liquid medium in the first chamber. However, it is possible to supply the required pressure to the liquid medium in first chamber by the use of a feeding member comprising such a piston element. Such power means may be a substantially arbitrary power member. The power member may be activated by a pneumatic, electric or hydraulic power source.

According to a preferred embodiment of the invention, the piston element comprises a second surface constituting a wall surface of a second chamber of the feeding member, wherein said means comprises a pressurized medium source and a valve member arranged to connect the medium source to the second chamber when the piston element is to provide a motion in said first feeding direction. By connecting a pressurized medium source with a sufficient pressure to the second chamber, it is possible to provide said feeding motion of the piston element in a relatively simple manner. The pressurized medium source may be a compressed air source. Compressed air is normally available in a milking stall. Therefore, it is suitable to use such a power source. Advantageously, the second surface of the piston element is larger than the first surface of the piston element. In many cases, the pressure of the available compressed air source is not enough for providing the required pressure of the liquid medium in the first chamber. Consequently, by such a design of said surfaces, the liquid medium in the first chamber may achieve a higher pressure than the compressed air source.

According to a further embodiment of the invention, said means are arranged to provide a motion of the piston element in a second retracting direction, which is opposite to the first feeding direction. Thereby, said means is used for providing both a feeding motion and a retracting motion of the piston element. Usually, the liquid medium is supplied from the liquid medium source to the liquid medium passage with an overpressure. In such a case, the valve member may be arranged to connect said second chamber to surrounding air when the piston element is to provide the second retracting motion. The liquid medium in the first chamber here achieves a higher pressure than the air in the second chamber. This pressure difference may be used for providing the retracting motion of the piston element.

According to an embodiment of the invention, the first chamber constitutes a part of a cylinder-shaped space, wherein the movable piston element comprises a piston, which divides the cylinder-shaped space in said first chamber and said second chamber. This embodiment requires a good sealing of the piston in the cylinder-shaped space between the liquid medium in the first chamber and the compressed air in the second chamber. According to an alternative embodiment, the feeding member comprises two cylinder-shaped spaces, wherein the movable piston element comprises a first piston, which divides the first cylinder-shaped space in said first chamber and in a third chamber, and a second piston, which divides the second cylinder-shaped space in said second chamber and in a fourth chamber. The first piston and the second piston may be connected by a piston rod. In such a case, the feeding member may comprise a pneumatic cylinder and a hydraulic cylinder, which comprise separate units. Thereby, the risk for leakage between the compressed air in the first chamber and the pressurized liquid medium in the second chamber is eliminated. The third chamber may be connected to surrounding air. Thereby, no overpressure which counteracts the retracting motion of the piston element exists in the third chamber. Advantageously, the feeding member may comprise a valve member, which is arranged to connect the fourth chamber to the surrounding air or to the pressurized medium source. When the fourth chamber is connected to the surrounding air, no overpressure exists in this chamber, and the feeding motion of the piston element is not in any way counteracted. When the fourth chamber is connected to the pressurized medium source, a quick retracting motion of the piston element is achieved.

According to a further preferred embodiment of the invention, the arrangement comprises two feeding members with separate piston elements and water passages, which, at least partly, are arranged in parallel. Thereby, it is possible to use the feeding members such that they supply the liquid medium independent of each other to the teat in the cup-shaped body. The two feeding members may have passages with different openings to the cup-shaped body. Thereby, it is possible to supply the liquid medium to one part of the teat by one of the feeding members and to another part of the teat by the other feeding member. The two feeding members may be arranged to work such that one feeding member provides a first feeding motion by its piston element when the other feeding member provides a second retracting motion by its piston element. In such a case, the liquid medium may be supplied continuously to the teat during a time period. The feeding of the liquid medium to the cup-shaped body may be continued during a time period comprising a plurality of feeding motions of the feeding members.

According to a preferred embodiment of the invention, the arrangement comprises a control unit, which is arranged to control the motions of the piston element such that a desired quantity of the liquid medium is fed to the cup-shaped body. Such a control unit may be a computer or the like with suitable software. The liquid medium may be a cleaning liquid and the cup-shaped body a teat-cleaning cup. Usually, the cleaning liquid is water or water provided with a suitable detergent. However, it is possible to supply liquid mediums of substantially arbitrary kinds with the arrangement. Such liquid mediums may be iodine, sun lotion and glycerol etc.

### BRIEF DESCRIPTION OF THE DRAWINGS

In the following, preferred embodiments of the invention are described by examples and with references to the attached drawings, in which

FIG. 1 shows an arrangement according to a first embodiment of the invention,

FIG. 2 shows an arrangement according to a second embodiment of the invention and

FIG. 3 shows an arrangement according to a third embodiment of the invention.

### BRIEF DESCRIPTION OF PREFERRED EMBODIMENTS OF THE INVENTION

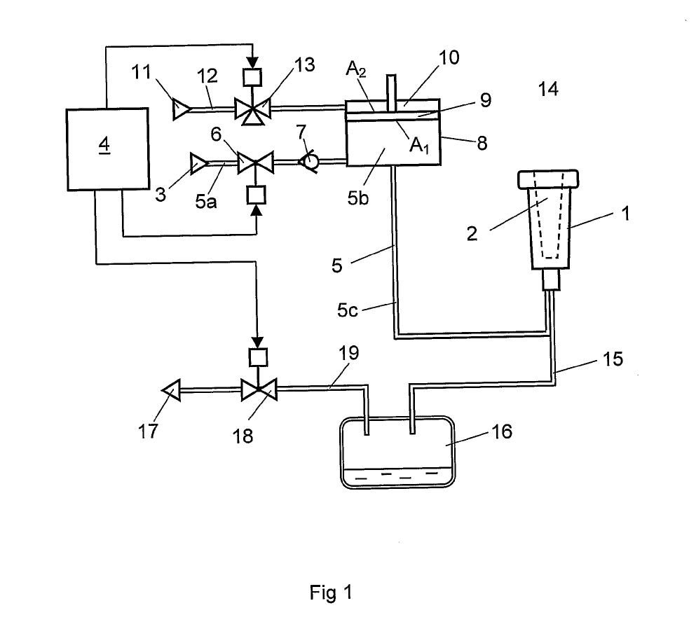

FIG. 1 shows an arrangement for supplying a cleaning liquid to a teat of a cow by means of a teat-cleaning cup 1. The teat-cleaning cup 1 has an inner space 2, which is arranged to receive the teat of a cow to be cleaned. The cleaning liquid is here water, which is supplied from a water source 3. The water has a pressure of about 1,5 to 4 bar in the water source 3. The arrangement comprises a control unit 4, which is arranged to control the feeding of water to the teat-cleaning cup 1. The arrangement comprises a water passage 5 having an extension from the water source 3 to at least one inlet opening to the inner space 2 of the teat-cleaning cup 1. The water passage 5 comprises a first conduit part 5a, which has an extension from the water source 3 to an inlet opening of a first chamber 5b. The control unit 4 is arranged to control the supply of the water to the first chamber 5b by means of a two-way valve 6 arranged in the first conduit part 5a. The first conduit part 5a comprises a one-way valve 7, which is arranged to prevent a back flow of the water in the first conduit part 5a.

The first chamber 5b constitutes a part of the water passage 5. The first chamber 5b also constitutes a part of a cylinder-shaped space 8. A movably arranged piston 9 divides the cylinder-shaped space 8 into the first chamber 5b and a second chamber 10. The piston 9 has a first surface A₁ constituting a wall surface of the first chamber 5b and a second surface A₂ constituting a wall surface of the second chamber 10. The water passage 5 comprises a second conduit part 5c, which has an extension from an outlet opening of the first chamber 5b to the inlet opening to the inner space 2 of the teat cleaning cup 1. A compressed air source 11, having an air pressure of about 6 bar, is connected to the second chamber 10 of the cylinder-shaped space 8 by means of an air conduit 12. The air conduit 12 comprises a three-way valve 13, such that it is possible to connect the second chamber 10 to the compressed air source 11 or to the surrounding air 14. The cup shaped body 1 comprises an outlet conduit 15 for removal of used water from the cleaning process in the teat-cleaning cup 1. The outlet conduit 15 ends in a collecting container 16, which is arranged to collect the used water. The collecting container 16 is connected to a vacuum source 17. The control unit 4 is arranged to control the supply of the vacuum to the outlet conduit 15 by means of a two-way valve 18 provided in a vacuum conduit 19.

Normally, the teat-cleaning cup 1 is used for cleaning the teats of a cow before a milking process is started. A milking robot may here grip the teat-cleaning cup 1 and hold it in a position such that the inner space 2 of the teat-cleaning cup 1 receives the teat to be cleaned. After that, the control unit 4 switches the two-way valve 18 to an open position such that vacuum is supplied to the inner space 2 via the outlet conduit 15. Thereby, the teat obtains a correct position in the inner space 2 of the teat-cleaning cup 1. The control unit 4 checks that the three-way valve 13 is in a position such that the second chamber 10 is connected to surrounding air 14. Thereafter, the control unit 4 switches the two-way valve 6 to an open position such that water from the water source 3 flows into the water passage 5. Since the water source 3 has a certain over pressure in relation to surrounding air 14, the supplied water to the first chamber 5b moves the piston 9 to an upper end position.

As soon as substantially the whole first chamber 5b has been filled with water, the control unit 4 switches the three-way valve 13 to a position in which the compressed air source 11 is connected to the second chamber 10. Thereby, the pressure in the second chamber 10 rises to a level, which substantially corresponds to the pressure of the air in the compressed air source 11. The compressed air in the second chamber 10 provides a pressure, via the second area A₂ and the first area A₁ of the piston 9, on the water in the first chamber 5b. The pressure in the second chamber 10 results in a motion of the piston 9 in the cylinder-shaped space 8 during which water is pressed out from the first chamber 5b, and is fed via the second conduit part 5c, before it is injected to the inner space 2 of the teat cleaning cup 1. The one-way valve 7 prevents a back flow of the water through the first conduit part 5a during the feeding motion of the piston 9.

When the piston 9 reaches a lowest end position in the cylinder-shaped space 8, the injection of water to the inner space 2 of the teat-cleaning cup 1 by means of the piston 9 is interrupted. The control unit 4 connects the second chamber 10 to the surrounding air 14 by means of the three-way valve 13. The pressure in the first chamber 5b is now higher than in the second chamber 10 and the piston 9 achieves a retracting motion towards an upper end position in the cylinder-shaped space 8. When the piston 9 has reached the upper end position, the control unit 4 has the possibility to provide a further feeding motion of the piston 9 by connecting the second chamber 10 to the compressed air source 11. The control unit 4 is arranged to initiate feeding motions of the piston 9 until a desired quantity of the water has been fed to the inner space 2 of the teat-cleaning cup 1. In this case, one feeding member is used, which comprises one cylinder-shaped space 8 and one piston 9.

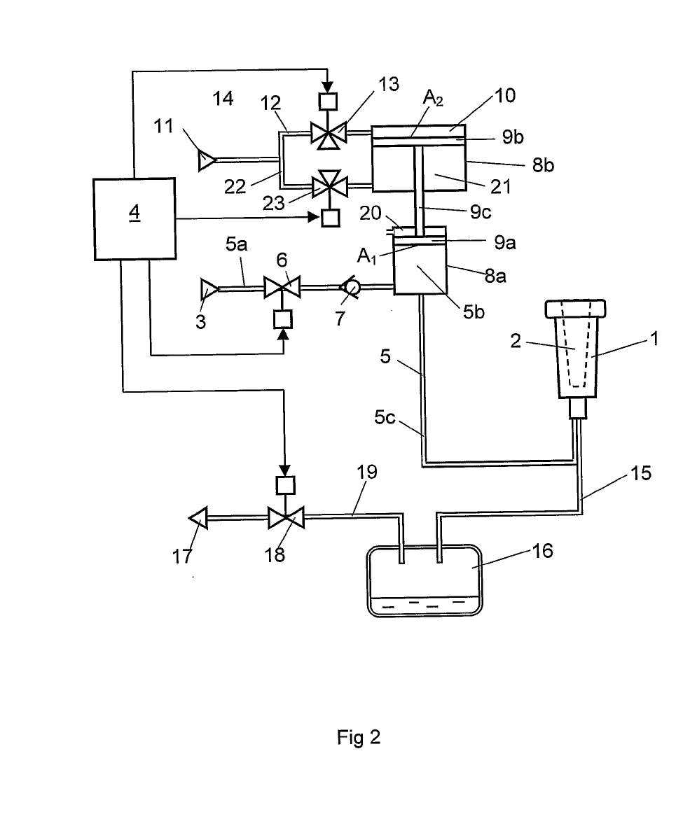

The second conduit 5c is however relatively narrow and it comprises portions in which flowing water obtains relatively large losses of pressure. In order to obtain an injection of the water to the inner space 2 of the teat-cleaning cup 1 with a suitable pressure, a higher pressure in the first chamber 5b than the pressure of the compressed air source 11 is normally required. FIG. 2 therefore shows an alternative arrangement for feeding a cleaning liquid to a teat of a cow by means of a teat-cleaning cup 1. In this case, one feeding member is used, which comprises two separate cylinder-shaped spaces 8a, b with one movable piston element 9a-c, The piston element 9a-c comprises a first piston 9a, a second piston 9b and a piston rod 9c, which connects the first piston 9a and the second piston 9b. The first piston 9a divides the first cylinder-shaped space 8a into a first chamber 5b and a third chamber 20. The third chamber 20 is continuously connected to surrounding air 14. The second piston 9b divides the second cylinder-shaped space 8b into a second chamber 10 and a fourth chamber 21. An air conduit 12 with a three-way valve 13 connects the compressed air source 11 to chamber 10 of the cylinder-shaped space 8b. Using the three-way valve 13 it is possible to connect the second chamber 10 alternatively to the compressed air source 11 or to surrounding air 14. The compressed air source 11 is connected to chamber 21 of the cylinder-shaped space 8b by means of an air conduit 22 arranged in parallel to the air conduit 12. The air conduit 22 comprises a three-way valve 23 such that it is possible to connect the fourth chamber 21 alternatively to the compressed air source 11 or to surrounding air 14.

When the teat-cleaning cup 1 is to be used, the control unit 4 checks that the three-way valve 13 is in a position such that the second chamber 10 is connected to surrounding air 14. The control unit 4 switches the three-way valve 23 to a position such that the fourth chamber 21 connects to the compressed air source 11. The pressure difference between the second chamber 10 and the fourth chamber 21 moves the pistons 9a, b to their upper end positions in the respective cylindrical shaped spaces 8a, b. Thereafter, the control unit 4 switches the two-way valve 6 to an open position such that water from the water source 3 flows into the water passage 5.

As soon as the passage 5 has been filled with water, the control unit connects the fourth chamber 21 to the surrounding air 14. At the same time, the second chamber 10 is connected to the compressed air source 11. Consequently, the rising pressure in the second chamber 10 substantially corresponds to the pressure of the air in the compressed air source 11. The third chamber 20 is also connected to surrounding air. Therefore, the pressure from the second chamber 10 is transmitted, via the piston 9, to the water in the first chamber 5b.

The water pressure in the first chamber 5b depends on the pressure of the compressed air source 11 and the ratio between the surface A₂ of the second piston 9b and the surface A₁ of the first piston 9a. Therefore, the surface A₂ of the second piston 9b is here larger than the surface A₁ of the first piston 9a. With a suitable design of these surfaces A₁, A₂, the first piston 9a is able to provide a suitable pressure to the water in the first chamber 5b, which results in an injection of water to the inner space 2 of the teat-cleaning cup 1 with a suitable pressure. The one-way valve 7 prevents a back flow of the water through the first conduit part 5a during the feeding motion of the piston 9a.

When the first piston 9a has reached the lowest end position in the cylinder-shaped space 8a, the pressure from the first piston 9a acting on the water in the first chamber 5b is interrupted. The control unit 4 connects the second chamber 10 to surrounding air 14 by means of the three-way valve 13 and the fourth chamber 21 to the compressed air source 11 by means of the three-way valve 23. Thereby, the piston 9a achieves a relatively quick retracting motion towards its upper end position in the cylinder-shaped space 8a. If the water pressure in the water source 3 is sufficiently high, it is possible to maintain a reduced flow of water to the inner space 2 of the teat-cleaning cup 1 during the retracting motion of the piston 9a. When the first piston 9a has reached the upper end position in the cylinder-shaped space 8a, the control unit 4 connects the second chamber 10 to the compressed air source 11 and the fourth chamber 21 to the surrounding air 14. Thereby, the feeding motion of water to the teat-cleaning cup 1 by means of the first pistons 9a is resumed. The control unit 4 activates the feeding member until a desired quantity of the water has been fed to the inner space 2 of the teat-cleaning cup 1.

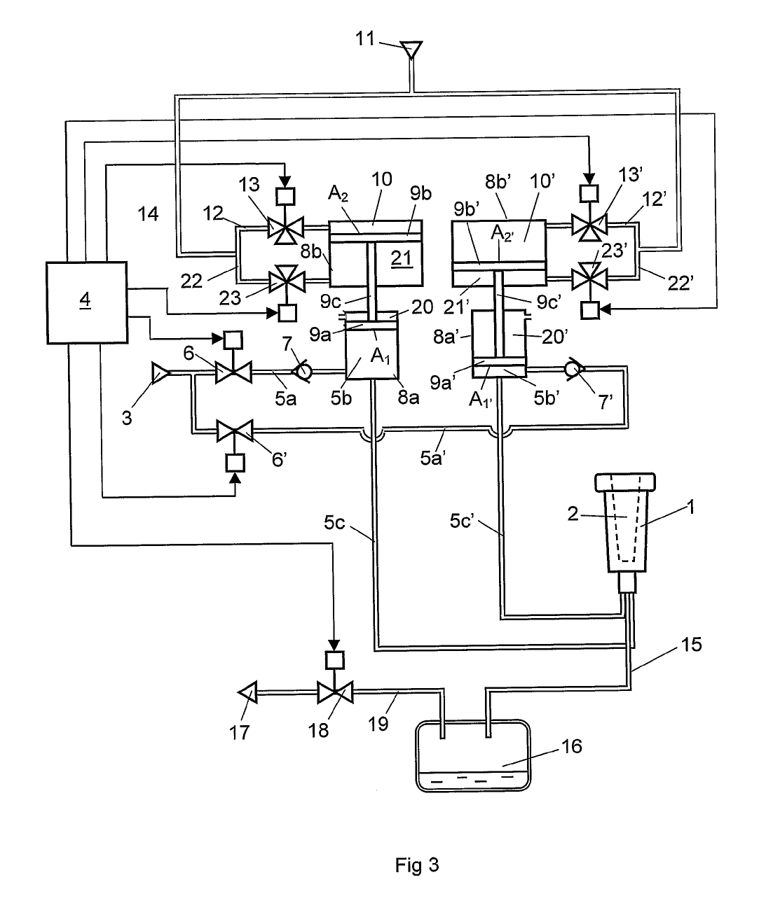

FIG. 3 shows a further alternative arrangement for feeding a desired quantity of a cleaning liquid to a teat-cleaning cup 1. In this case, two feeding members are used having separate piston elements 9a-c, 9a′-c′ and separate passages 5, 5′ to the teat-cleaning cup 1. Each of the feeding members has a function according to the feeding member shown in FIG. 2. Therefore, the function of this embodiment is not explained in detail. The two feeding members may be activated by the control unit 4 such that when the piston element 9a, b of one feeding member provides a feeding motion, the piston element 9a′, b′ of the other feeding member provides a retracting motion. Consequently, by the use of two such feeding members, a continuous injection of water to the inner space 2 of the teat-cleaning cup 1 is guaranteed until a desired quantity of water has been supplied to the teat. The second conduits 5c, 5c′ of the feeding members may have different openings to the inner space 2 of the teat-cleaning cup 1. Thereby, it is possible to use the different feeding members for supplying water to different parts of the teat in the teat-cleaning cup 1. Such a supply of water to different parts of the teat may be provided at different moments or simultaneously.

The invention is not limited to the described embodiments but may be varied and modified freely within the scope of the claims. An arbitrary number of feeding members may be used for supplying a cleaning liquid to different parts of a teat. The arbitrary numbers of feeding members may supply the water at different moments or simultaneously to different parts of the teat.

1. An arrangement for supplying a liquid medium to a teat of an animal, wherein the arrangement comprises:
a cup-shaped body which is arranged to receive the teat of the animal;
a liquid medium source which contains the liquid medium to be supplied to the animal;
at least one liquid medium passage having an extension from the first medium source to at least one opening to the cup-shaped body and at least one feeding member, arranged to fee a desired quantity of the liquid medium through the passage to the cup-shaped body,
wherein said at least one feeding member comprises a piston element having a first surface which constitutes a wall surface of a first chamber of the passage, and means arranged to provide a motion of the piston element in a first feeding direction in the first chamber, such that liquid medium is fed to the cup-shaped body.

2. An arrangement according to claim 1, wherein the at least one piston element comprises a second surface constituting a wall surface of a second chamber of the feeding member, wherein said means comprise a pressurized medium source and a valve member arranged to connect the medium source to the second chamber when the piston element is to provide a motion in said first feeding direction.

3. An arrangement according to claim 2, wherein the pressurized medium source is a compressed air source.

4. An arrangement according to claim 2, wherein the second surface of the piston element is larger than the first surface of the piston element.

5. An arrangement according to claim 1, wherein said means to provide a motion of the piston element in a first feeding direction are arranged to provide a motion of the piston element in a second retracting direction, which is opposite to the first feeding direction.

6. An arrangement according to claim 2 wherein that said means to provide a motion of the piston element in a first feeding direction are arranged to provide a motion of the piston element in a second retracting direction, which is opposite to the first feeding direction and wherein the valve member is arranged to connect said second chamber to surrounding air when the piston element is to provide the second retracting motion.

7. An arrangement according to claim 1, wherein the first chamber constitutes a part of a cylinder-shaped space, wherein the movable piston element comprises a piston which divides the cylinder-shaped space into said first chamber and said second chamber.

8. An arrangement according to claim 1, wherein the at least one feeding member comprises two cylinder-shaped spaces, wherein the movable piston element comprises a first piston which divides the first cylinder-shaped space into said first chamber and a third chamber, and a second piston which divides the second cylinder-shaped space into said second chamber and a fourth chamber.

9. An arrangement according to claim 8, wherein the third chamber is connected to surrounding air.

10. An arrangement according to claim 8 wherein the at least one feeding member comprises a valve member which is arranged to connect the fourth chamber to the surrounding air or to the pressurized medium source.

11. An arrangement according to claim 1, wherein the arrangement comprises at least two feeding members with separate piston elements and water passages, which passages at least partly, are arranged in parallel.

12. An arrangement according to claim 11, wherein the at least two feeding members have passages with different openings to the cup-shaped body.

13. An arrangement according to claim 11 wherein wherein said feeding members are arranged to work such that one feeding member provides a first feeding motion by its piston element when the other member provides a second retracting motion of its piston element.

14. An arrangement according to claim 1, wherein the arrangement comprises a control unit which is arranged to control the motions of the at least one piston element such that a desired quantity of the liquid medium is fed to the cup-shaped body.

15. An arrangement according to claim 1, wherein the liquid medium comprises a cleaning liquid.

16. An arrangement according to claim 15, wherein the cleaning liquid comprises water.

17. An arrangement according to claim 3, wherein the second surface of the piston element is larger than the first surface of the piston element.

18. An arrangement according to claim 7, wherein the at least one feeding member comprises two cylinder-shaped spaces, wherein the movable piston element comprises a first piston which divides the first cylinder-shaped space into said first chamber and a third chamber, and a second piston which divides the second cylinder-shaped space into said second chamber and a fourth chamber.

19. An arrangement according to claim 18, wherein the arrangement comprises at least two feeding members with separate piston elements and water passages, which passages, at least partly, are arranged in parallel.

20. An arrangement according to claim 18, wherein the arrangement comprises a control unit which is arranged to control the motions of the at least one piston element such that a desired quantity of liquid is fed to the cup-shaped body.
